(19) United States
(12) Patent Application Publication
(10) Pub. No.: US 2008/0119800 A1
(43) Pub. Date: May 22, 2008

(54) Therapeutic facemask

(76) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(21) Appl. No.: 11/603,711

(22) Filed: Nov. 22, 2006

(51) Int. Cl. A61H 33/04

(52) U.S. Cl. 604/303

(57) ABSTRACT

A therapeutic facemask (10) includes a main body (12). The main body (12) includes a hydrophilic core (20), and a moisture permeable membrane (22) in which the hydrophilic core (20) is enclosed.

### FIELD

The present inventive subject matter relates to the art of therapeutic facemasks. One particular application is found in conjunction with a therapeutic facemask for humidifying the eye region of the wearer, and the specification makes particular reference thereto. However, it is to be appreciated that aspects of the present inventive subject matter are also amenable to other like applications.

### BACKGROUND

In many instance, an individual may find themselves in an environment with dry air. For example, dryness is often encountered in desert locations, on airplane flights, etc. Extended exposure to a dry atmosphere or dry air can lead to irritation of the eyes. A dry atmospheric condition can be particularly problematic for certain individuals, e.g., individuals that wear contact lenses, individuals with various forms of eye conditions or aliments, individuals that have recently had eye surgery or the like, individuals with sensitive eyes, etc.

Adding moisturizing eye drops to one's eyes is an option that is available to address dryness when it is experienced. However, this solution has certain limitations and/or drawbacks. For example, some eye drops are not safe for contact lens wearers. Additionally, adding eye drops to one's eyes may overly wet the eyes, or if the environment is particularly dry or an individual remains in the dry environment for a significant period of time, then the individual may have to repeated add the eye drops to their eyes. Furthermore, at nighttime for example or when an individual otherwise desires to sleep or rest, the adding of eye drops to one's eyes can interrupt that individual's sleep or rest. Also, an individual with unsteady hands or an aversion to putting anything in their eye may find it difficult to properly administer the eye drops. Likewise, a parent, caretaker or the like attempting to administer the eye drops to a child or other individual may encounter difficulty if that child or other individual squirms or is otherwise unable or unwilling to cooperate.

Accordingly, a new and improved therapeutic facemask is disclosed that overcomes the above-referenced problems and others.

### SUMMARY

In accordance with one embodiment, a therapeutic facemask is provided. The facemask includes: a main body made of a moisture permeable membrane surrounding a hydrophilic core disposed within the membrane.

In accordance with another embodiment, a therapeutic facemask includes a main body. The main body has: a liquid absorbing core; and, a vapor permeable membrane in which the core is enclosed.

In accordance with another embodiment, a method of relieving eye dryness includes: providing a facemask including a liquid absorbing core enclosed in a vapor permeable membrane; supplying a liquid to the core of the facemask; and, placing the facemask on a wearer's face.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagram illustrating a exemplary therapeutic facemask embodying aspect of the present inventive subject matter.

FIG. 2 is a diagram illustrating a cross-section view of the facemask shown in FIG. 1.

### DETAILED DESCRIPTION

For clarity and simplicity, the present specification shall refer to structural and/or functional elements, components and/or features that are commonly known in the art without further detailed explanation as to their configuration or operation except to the extent they have been modified or altered in accordance with and/or to accommodate the embodiment(s) presented herein.

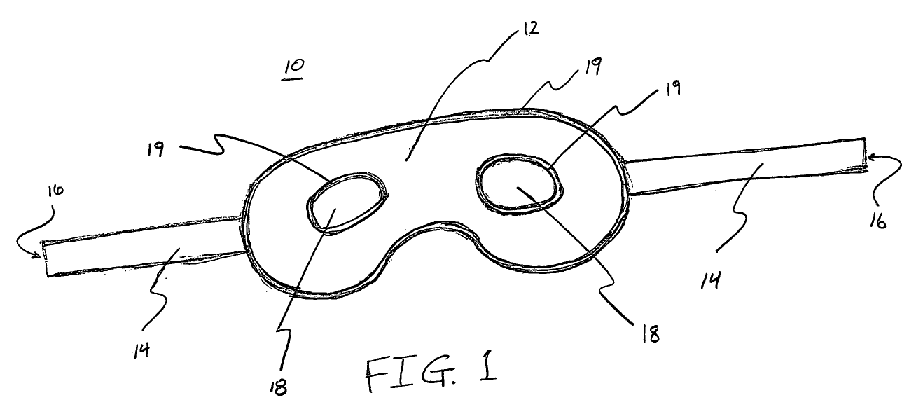

With reference to FIGS. 1, there is shown a therapeutic facemask 10. As illustrated, the facemask 10 includes a main body 12. Extending from opposite sides of the main body 12 are straps 14. When in use, the main body 12 of facemask 10 is positioned on the face of a wearer and the straps 14 are wrapped around the wearer's head to selectively secure the facemask 10 thereto. Optionally, the straps 14 may be implemented as any suitable elongated flexible member, e.g., a cord, a rope, or the like. As illustrated, there are two straps 14 that may be selectively attached or joined to one another at their distal ends 16. For example, this is achieved by tying the ends 16 together. Alternately, the ends 16 are optionally provisioned with other suitable fasteners, e.g., a hook-and-loop type fastener, a buckle, d-rings, snaps or buttons, etc. Optionally, a single strap 14 is provided extending from one side of the main body 12. Suitably, in the single strap embodiment, to secure the facemask 10 to the wearer's head, the strap 14 wraps entirely around the wearer's head and is selectively fastened to the opposite side of the main body 12. In any case, optionally, one or more of the straps 14 are selectively adjustable in length (or the respective fastener is selectively adjustable) so as to permit the facemask 10 to fit different size heads.

In the illustrated embodiment, the main body 12 has formed therein a pair of openings or eye holes 18 dimensioned to accommodate and arranged to coincide or otherwise align with a wearer's eyes when the facemask 10 is positioned on the wearer's face. Optionally, a single opening is formed large enough to accommodate both eyes.

In one suitable embodiment, the mask 10 is also optionally provisioned with or otherwise includes a rigid or semi-rigid frame 19, e.g., arranged around the perimeter of the main body 12 and/or the eye holes 18. Suitably, the frame is constructed of plastic or another suitable material and helps to define the shape of the mask 10 and/or optionally serve as connection or attachment point for the straps 14.

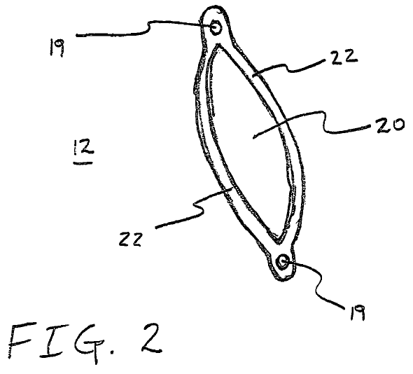

With reference to FIG. 2, the main body 12 of the facemask 10 comprises a hydrophilic or otherwise liquid absorbing core 20 enclosed and/or otherwise contained in a moisture or vapor permeable membrane 22, e.g., a fine plastic mesh or other like material. Optionally, the membrane material also extends from either side of the main body 12 of the mask 10 to form the straps 14. Suitably, the membrane material (as well as the core material) is optionally any of a variety of different colors as desired and/or may be any desired degree of opaqueness. However, some degree of transparency or at least translucency may be advantageous when used in public so as to not give the appearance that the wearer is attempting to disguise their identity. In any event of course, it is up to the wearer to exercise sound judgment in choosing when and/or where to don the mask 10. For example, it may be ill advised for an individual to wear the mask 10 when boarding an airplane, when passing through security check points, when entering a bank, etc.

The core 20 is optionally made from any one or more suitable materials and is optionally formed from a unitary mass or an aggregate of particles or collection of granular material. For example, the material used for the core 20 is optionally any of a variety of suitable sponges. Another suitable material which is optionally used to make the core 20 is polyphenolic foam (also commonly know as florist foam). Additionally, known hydrophilic gels or water absorbing polymers make suitable materials for the core 20. These materials are generally starch or acrylic polymers which are formulated as granules or flakes and are in some instances capable of holding over 150 times their dry weight when fully charged with water. Typically, after the granules or flakes absorb water, they swell and assume a gel-like consistency.

Generally, to prepare the mask 10 for use by an individual, it is first charged. That is to say, the mask 10 is soaked in or otherwise permitted to absorb a quantity of water and/or optionally another suitably therapeutic, soothing and/or medicinal liquid. Suitably, as the core 20 absorbs the charging liquid, it will swell. Accordingly, the individual is able to ascertain when the mask 10 is sufficiently charged by observing the amount of swelling exhibited.

Once charged to the desired degree with water and/or another suitable liquid, the main body 12 of the mask 10 is positioned on the user's face and the mask 10 is secured in place to the user's head, e.g., via the straps 14. Having been so arranged on the wearer, the core 20 slowly allows the captured water and/or other liquid therein to vaporize and the membrane 22 permits the vapor to pass therethrough, thereby creating a relatively more moist and/or humid microclimate or micro-environment in the vicinity or close proximity of the wear's eyes. It is to be appreciated that the significant difference in the partial pressures of gaseous H₂O contributes to the vaporization and/or release of the water and/or other vapor from the core 20, particularly on the front side of the mask 10 (i.e., the side away from the wearer's face). Of course, vapor would also exit the mask 10 from the inside surface (i.e., the side next to the wearer's face) and this is potentially augmented and/or enhanced by a difference in temperature between the mask 10 and the wearer's skin.

Suitably, the facemask 10 is easily cleaned and/or sterilized by wiping the external surface with an alcohol pad or otherwise washing the external surface with some other suitable solution. Optionally, the facemask 10 may be microwaved as a further means of sterilization. As another option to promote cleanliness, sterile water may be used to charge the mask 10 as opposed to tap water.

Additionally, the facemask 10 may be warmed in a microwave or cooled a refrigerator to achieve a desired temperature before wearing. Similarly, the charging liquid may be heated or cooled to a desired temperature prior to introducing the mask 10 for charging. Of course, other suitable methods for adjusting the mask's temperature to a comfortable or otherwise desirable level are also contemplated.

Of course, it is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A therapeutic facemask comprising:
a main body, said main body comprising;
a hydrophilic core; and,
a moisture permeable membrane in which the hydrophilic core is enclosed.

2. The facemask of claim 1, further comprising:
a strap extending from the main body, said strap being arranged to selectively secure the facemask to a wearer's head.

3. The facemask of claim 2, wherein the main body has one or more openings formed therein, said openings arranged to align with the wearer's eyes when the facemask is secured to the wearer's head.

4. The facemask of claim 1, wherein the hydrophilic core is made of a polyphenolic foam.

5. The facemask of claim 1, wherein the hydrophilic core is made of a hydrophilic gel.

6. The facemask of claim 1, wherein the hydrophilic core is made of a water absorbent polymer.

7. The facemask of claim 1, wherein the hydrophilic core is made of a sponge.

8. The facemask of claim 1, wherein the hydrophilic core is made of particles of material.

9. The facemask of claim 1, wherein the moisture permeable membrane is made of a fine plastic mesh.

10. A therapeutic facemask comprising:
a main body, said main body comprising;
a liquid absorbing core; and,
a vapor permeable membrane in which the core is enclosed.

11. The facemask of claim 10, wherein the main body has one or more openings formed therein, said openings arranged to align with a wearer's eyes when the facemask is positioned on the wearer's face.

12. The facemask of claim 11, further comprising:
securing means extending from the main body, said securing means being arranged to selectively secure the facemask to the wearer's head.

13. A method of relieving eye dryness, said method comprising:
a) providing a facemask including a liquid absorbing core enclosed in a vapor permeable membrane;
b) supplying a liquid to the core of the facemask; and, c) placing the facemask on a wearer's face.

14. The method of claim 13, further comprising:
d) securing the face mask to the wearer's head.
